(19) United States
(12) Patent Application Publication
(10) Pub. No.: US 2008/0280752 A1
(43) Pub. Date: Nov. 13, 2008

(54) Catalyst powder production method, catalyst powder and catalyst layer in fuel cell

(75) Inventors: Masao Okumura, Toyota-shi (JP); Satoshi Kadotani, Owariasahi-shi (JP); Tatsuya Hatanaka, Aichi-ken (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 12/149,069

(22) Filed: Apr. 25, 2008

(30) Foreign Application Priority Data
May 9, 2007 (JP) 2007-124274

(51) Int. Cl. B01J 35/00; B01J 37/00

(52) U.S. Cl. 502/100

(57) ABSTRACT

A catalyst powder production method for constructing a catalyst layer in a fuel cell includes: forming a mixture that contains an electrolyte, a pore-forming material, and a catalyst-supporting particle that supports a catalyst; producing a composite powder in which the catalyst-supporting particle and the electrolyte are attached to a periphery of the pore-forming material by using the mixture; and producing the catalyst powder in the form of hollow particle by removing the pore-forming material from the composite powder.

### INCORPORATION BY REFERENCE

The disclosure of Japanese Patent Application No. 2007-124274 filed on May 9, 2007 including the specification, drawings and abstract is incorporated herein by reference in its entirety.

### BACKGROUND OF THE INVENTION

1. Field of the Invention

The invention relates to a catalyst powder production method, a catalyst powder and a catalyst layer in a fuel cell.

2. Description of the Related Art

In general, a polymer electrolyte fuel cell is provided with a membrane-electrode assembly (hereinafter, referred to as “MEA”) including an electrolyte membrane, a catalyst layer formed on the electrolyte membrane, and a gas diffusion layer formed on the catalyst layer. The catalyst layer includes an electrolyte, and particles such as carbon supporting a catalyst such as platinum. A formation method for the catalyst layer is described in Japanese Patent Application Publication No. 10-189002 (JP-A-10-189002). According to JP-A-10-189002, a slurry is obtained by mixing catalyst-supporting particles, the electrolyte and a solvent. Then, catalyst particles (powder) are produced by spray drying. Then, the catalyst powder is made into a solution with a solvent such as alcohol, and the solution is spread on a carbon paper that is used as a gas diffusion layer. Finally, the catalyst layer is formed by filtering out the solvent.

In the fuel cells, so-called “flooding” phenomenon may occur, which refers to a case where the produced water due to the electrochemical reaction in the fuel cell and the reactant gas-humidifying water are present in excess, and thereby the diffusion of the reactant gases is impeded and the power generation performance degrades. Also, so-called “dry-up” phenomenon may occur, which refers to a case where water in the electrolyte membrane is lacking, and thereby the power generation performance degrades However, according to JP-A-10-189002, considerations for restraining the dry-up phenomenon or the flooding phenomenon in the fuel cells when the catalyst powder is produced are not sufficiently taken.

### SUMMARY OF THE INVENTION

The invention provides a catalyst powder production method, a catalyst powder and a catalyst layer that restrains the occurrence of the dry-up phenomenon and the flooding phenomenon in a fuel cell.

A catalyst powder production method according to a first aspect of the invention includes: forming a mixture that contains an electrolyte, a pore-forming material, and a catalyst-supporting particle that supports a catalyst; producing a composite powder in which the catalyst-supporting particles and the electrolyte are attached to a periphery of the pore-forming material by using the mixture; and producing the catalyst powder that has a hollow structure by removing the pore-forming material from the composite powder.

In the catalyst powder production method according to the first aspect, the catalyst powder is produced by removing the pore-forming material present in the center of the composite powder particle. Therefore, in a fuel cell that employs this catalyst powder, water is held within the catalyst powder during a wet state, so that the occurrence of the flooding phenomenon may be restrained. During a dry state, on the other hand, the water held within the catalyst powder is discharged, so that the occurrence of the dry-up phenomenon may be restrained. Besides, since the catalyst powder is made in the form of hollow particles, the usage of the costly catalyst may be reduced, and rise in the manufacturing cost of the fuel cell may be restrained, in comparison with a catalyst powder having a non-hollow structure.

A catalyst powder according to a second aspect of the invention includes: an electrolyte; and a catalyst-supporting particle that supports a catalyst, which the catalyst powder has a hollow structure.

A catalyst layer in a fuel cell according to a third aspect of the invention includes the hollow-structured catalyst powder.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a flowchart showing a procedure of a catalyst powder production process as an embodiment of the invention;

FIG. 2 schematically shows a procedure of the catalyst powder production process;

FIG. 3 shows a general construction of a fuel cell that employs a catalyst powder produced by the catalyst powder production process;

FIGS. 4A and 4B schematically show migration of water in and out of the catalyst powder constituting a cathode-side catalyst layer and an anode-side catalyst layer;

FIG. 5 shows an I-V characteristic of a fuel cell that employs the catalyst powder produced in an example of the invention, and an I-V characteristic of a comparative example; and

FIG. 6 schematically shows a production procedure for a catalyst powder in the comparative example.

### DETAILED DESCRIPTION OF EMBODIMENTS

Embodiments of the invention will be described hereinafter with reference to the drawings.

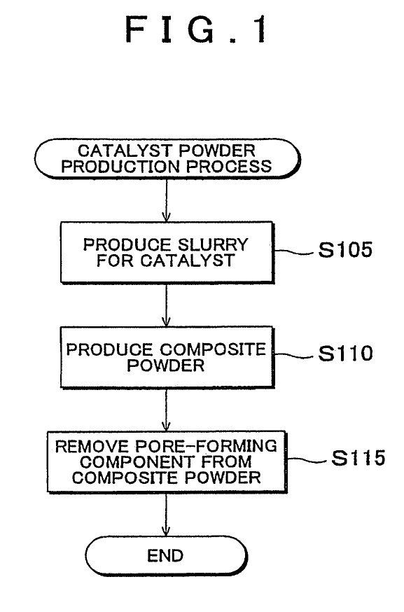

FIG. 1 is a flowchart showing a procedure of a catalyst powder production process as an embodiment of the invention. In step S105, catalyst-supporting particles, an electrolyte, a solvent and a pore-forming material are mixed to produce a slurry (ink) for the catalyst. The catalyst-supporting particles used herein may be particles of a carbon supporting thereon platinum (Pt), a carbon supporting thereon platinum and a different metal such as ruthenium (Ru) or the like, etc. The electrolyte used herein is not particularly restricted as long as the electrolyte has a high conductivity of ions, such as protons (H⁺) or the like. Examples of the electrolyte include a perfluorosulfonic acid-based solid polymer electrolyte. Concretely, Nafion® of DuPont, Aciplex® of Asahi Kasei Corporation, Flemion® of Asahi Glass Corporation, etc. may be used. The solvent used herein is not particularly restricted as long as the solvent can dissolve and disperse the electrolyte. Examples of the solvent include organic solvents, such as alcohol-based solvents such as methanol, ethanol, etc., ketone-based solvents such as an acetone, acetone or the like. An alcohol-based solvent is preferable in view of the ease of handling, and the high dispersibility of catalyst-supporting particles.

The “pore-forming material” is used to form a hollow structure inside the catalyst powder as described below. The pore-forming material used herein is preferably made of a material that sublimes at relatively low temperature. Examples of the pore-forming material include camphor (C₁₀H₁₆O), naphthalene, α-naphthol, para-dichlorobenzene, etc. Then, the catalyst-supporting particles, the electrolyte, the solvent and the pore-forming material are mixed with each other, and the mixture may be dispersed by using a disperser such as a stirring mill and an ultrasonic disperser. It is also possible to adopt a construction in which, in comparison between the size of the catalyst-supporting particles and the particles of the electrolyte in the slurry for the catalyst and the size of the particles of the pore-forming material, the particles of the pore-forming material are larger. A reason for adopting the construction in which there is a difference in size between the particles will be described.

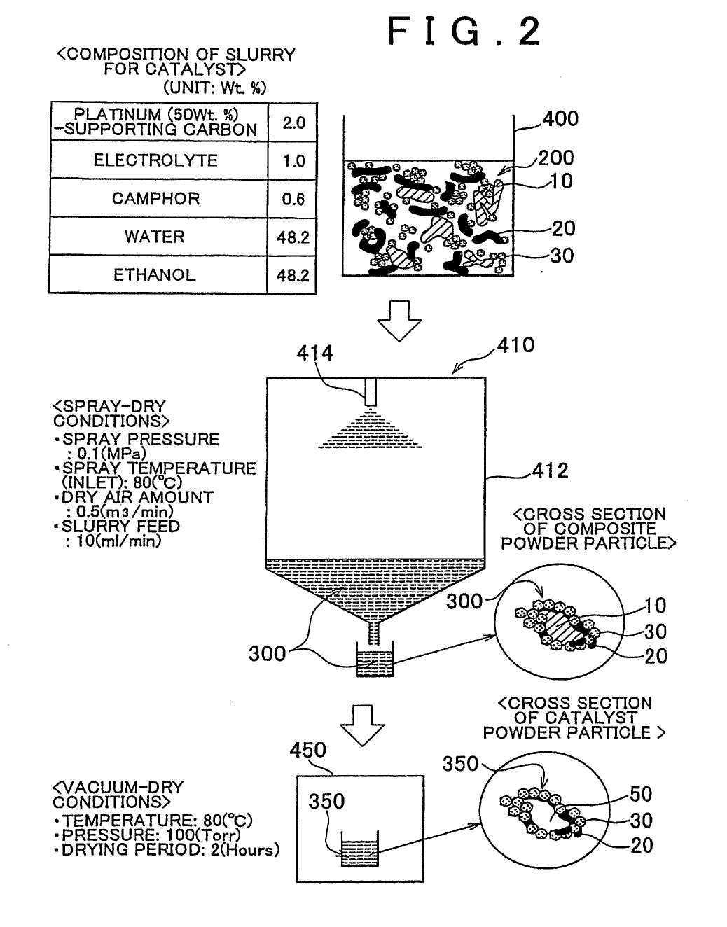

FIG. 2 schematically shows a procedure of the catalyst powder production process. Firstly, a platinum-supporting carbon (50 wt. % of the supported platinum) as catalyst-supporting particles, Nafion 20 as an electrolyte, and camphor 10 as a pore-forming material are added to a mixed solvent of water and ethanol, and are mixed and dispersed therein to obtain a slurry 200 for the catalyst. The slurry 200 for the catalyst may be regarded as a “mixture” in the invention. In the slurry 200 for the catalyst, for example, the particle diameter of the platinum-supporting carbon and Nafion is about 0.1 to 0.2 μm, and the average particle diameter of camphor is about 0.3 to 0.5 μm. Such a difference in the average particle diameter may be achieved, for example, in the following manner. Firstly, the platinum-supporting carbon and Nafion are added to and dispersed in the mixed solvent so that the particle diameter of the platinum-supporting carbon and Nafion in the mixture becomes sufficiently small. Then, camphor is added to the mixture, and simply mixed with each other without dispersing the camphor. Alternatively, the platinum-supporting carbon, Nafion and camphor are firstly formed in different sizes as a pre-process, and then only adding and mixing processes during which the above materials is added to the mixed solvent and mixed as in step S105 in FIG. 1 may be performed.

In the case where the platinum-supporting carbon, Nafion, the mixed solvent of water and ethanol, and camphor are used, camphor may be mixed in at the following weight ratio. That is, in a slurry composition in which the weight ratio of the platinum-supporting carbon (50 wt. % of the supported platinum) is 2.0 wt. % and the weight ratio of Nafion is 1.0 wt. %, camphor may be mixed so that the weight ratio thereof is within the range of 0.1 wt. % to 4.0 wt. %. In particular, camphor may also be mixed so that the weight ratio thereof is within the range of 0.3 wt. % to 2.0 wt. %.

In step S110 (FIG. 1), using the slurry for the catalyst produced in step S105, a composite powder made up of the catalyst-supporting particles, the electrolyte and the pore-forming material is produced. That is, by a spray dry method that uses a spray dryer 410 as shown in FIG. 2, the slurry 200 for the catalyst is spray-dried to produce a composite powder 300. Concretely, the slurry 200 for the catalyst is sprayed into a chamber 412 by an atomizer 414 of the spray dryer 410, so that due to the contact dry air, the sprayed mist of the slurry instantaneously dries, thus providing a composite powder. The thus-provided composite powder has a structure in which the camphor 10, that is, the pore-forming material, serves as a center, and the periphery of the camphor 10. (i.e., the particle surface thereof) is covered with the platinum-supporting carbon 30 and the electrolyte 20. The term “cover” herein means that the platinum-supporting carbon 30 and the electrolyte 20 covers the entire surface of the camphor 10, and also means that it covers a portion of the surface of the camphor 10. In addition, this structure of the composite powder is formed because the camphor 10, present in the form of particles that are larger in particle diameter than the particles of the platinum-supporting carbon and the electrolyte, forms cores on which the platinum-supporting carbon 30 and the electrolyte 20 attach to each other.

In step S115 (FIG. 1), the pore-forming material is removed from the composite powder produced in step S110, so as to produce a hollow-particle catalyst powder. In the case where a substance that exhibits sublimation at relatively low temperature, such as camphor or the like, is used as a pore-forming material, the pore-forming material may be removed from the composite powder through sublimation by heating the catalyst powder at relatively low temperature (e.g., about 150° C. or less) and reducing the pressure. Concretely, as shown in FIG. 2, the composite powder 300 is heated and dried by using a vacuum dryer 450. As a result of this drying step, the camphor 10 is removed by sublimation from the composite powder 300 to produce the catalyst powder 350 in a hollow particle form.

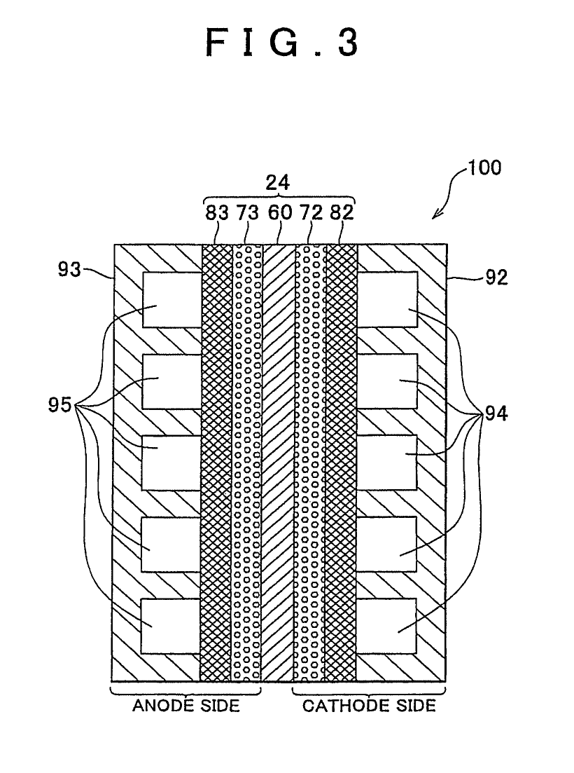

FIG. 3 shows a general construction of a fuel cell that employs a catalyst powder produced by the catalyst powder production process of the embodiment. This fuel cell 100 includes an MEA 24, a cathode-side separator 92, and an anode-side separator 93. Each of the cathode-side separator 92 and the anode-side separator 93 is constructed of a stainless steel sheet. The two separators 92, 93 are disposed so as to sandwich the MEA 24. The MEA 24 includes an electrolyte membrane 60, a cathode-side catalyst layer 72 formed on the electrolyte membrane 60, an anode-side catalyst layer 73 formed on a surface of the electrolyte membrane 60 opposite from the cathode-side catalyst layer 72, a cathode-side gas diffusion layer 82 formed on the outer side of the cathode-side catalyst layer 72, and an anode-side gas diffusion layer 83 formed on the outer side of the anode-side catalyst layer 73.

Each of the two gas diffusion layers 82, 83 is constructed of a carbon paper. A surface of the cathode-side separator 92 has a projections-and-depressions shape such that an oxidizing gas channel 94 through which an oxidizing gas flows is formed between the cathode-side separator 92 and the cathode-side gas diffusion layer 82. Similarly, a fuel gas channel 95 through which a fuel gas flows is formed between the anode-side separator 93 and the anode-side gas diffusion layer 83.

The cathode-side catalyst layer 72 may be formed by using the catalyst powder 350 that is produced by the foregoing method. Concretely, the cathode-side catalyst layer 72 may be formed by the dry application of the catalyst powder 350 to the electrolyte membrane 60 or the cathode-side gas diffusion layer 82. Examples of the method for the dry application that may be used herein include an electrostatic screen method in which the catalyst powder 350 is applied by dropping the powder through a screen having a predetermined pattern through the utilization of static voltage, an electrophotographic method in which the electrically charged catalyst powder 350 is electrostatically attached to a photosensitive drum that has been electrically charged in a predetermined pattern, and then the catalyst powder 350 on the photosensitive drum is transferred to a carbon paper, a spray method in which the catalyst powder 350 is applied by spraying, etc.

After the catalyst powder 350 is applied to the electrolyte membrane 60 or the cathode-side gas diffusion layer 82, the catalyst powder 350 is fixed by applying thereto heat and pressure through the use of a plane press machine or a roll press machine. Incidentally, the fixation conditions in the case where a plane press machine is used may be, for example, that the temperature is 130° C., the pressure is 5 MPa, and the pressing time is 5 minutes. The anode-side catalyst layer 73 may be formed in the same manner.

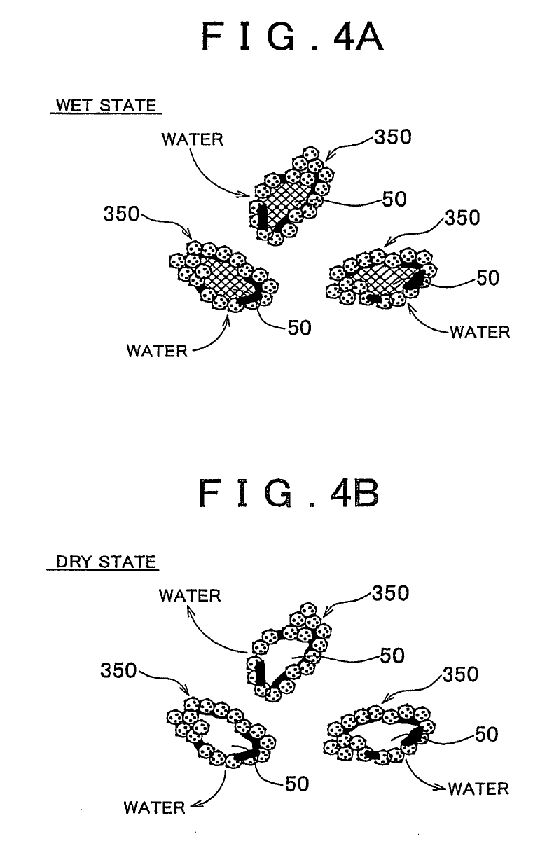

FIGS. 4A and 4B schematically show the migration of water in and out of the catalyst powder 350 constituting the cathode-side catalyst layer 72 and the anode-side catalyst layer 73. If, during the operation of the fuel cell 100, the internal water content becomes excess and brings about a wet state as shown in FIG. 4A, water enters holes 50 within particles of the catalyst powder 350. Therefore, the inhibition of gas diffusion by water residing in a catalyst layer may be restrained, and thus the occurrence of the flooding phenomenon may be restrained. On the other hand, when the temperature of the fuel cell 100 becomes high so that a dry state is brought about as shown in FIG. 4B, the water held in the holes 50 in particles of the catalyst powder 350 is discharged out. Therefore, the electrolyte membrane 60 does not become excessively dry, so that the occurrence of the dry-up phenomenon caused by low proton conductivity may be restrained.

Since the catalyst powder 350 has the hollow structure, the usage of the costly catalyst may be reduced, and rise in the manufacturing cost of the fuel cell 100 may be restrained, in comparison with a catalyst powder having a non-hollow structure. It is to be noted herein that the electrochemical reaction in the fuel cell 100 mostly occurs on the outer hull of each particle of the catalyst powder 350 where the reactant gas is likely to contact the catalyst, and therefore that while the particles of the catalyst powder 350 have a hollow interior, the hollow structure thereof causes substantially no degradation of the performance of the catalyst.

Besides, since the pore-forming material (e.g., the camphor 10) is removed by heating and pressure reduction at the stage of the composite powder 300 as shown in FIG. 2, the degradation of the electrolyte membrane caused by heating or pressure reduction may be restrained, in comparison with the case where the pore-forming material is removed after the catalyst layer is formed on the electrolyte membrane. Besides, since the pore-forming material used herein is the camphor 10 that sublimes at relatively low temperature and at relatively high pressure, it is possible to restrain the degradation of the electrolyte 20 in the composite powder 300 when the composite powder 300 is vacuum-dried in step S115 in FIG. 1.

### EXAMPLES

Following the process steps shown in FIGS. 1 and 2, catalyst powders were produced. In step S105 (FIG. 1), the platinum-supporting carbon 30 (50 wt. % of the supported platinum), Nafion 20 as an electrolyte, the camphor 10 as a pore-forming material were added to a mixed solvent made up of water and ethanol in a mixing vessel 400 (FIG. 2), and the mixture was stirred to produce a slurry 200 for the catalyst. In this step, the materials were mixed so that the composition of the slurry 200. for the catalyst became as follows. That is, the composition of the slurry 200 was 2.0 wt. % of the platinum-supporting carbon, 1.0 wt. % of the electrolyte, 0.6 wt. % of camphor, 48.2 wt. % of water, and 48.2 wt. % of ethanol.

In step S110 (FIG. 1), the slurry 200 for the catalyst (FIG. 2) was spray-dried in the following spraying conditions to produce the composite powder 300. That is, the spray pressure was 0.1 MPa. The spray pressure refers to the pressure at which the slurry for the catalyst is sprayed from the atomizer 414 into chamber 412. Besides, the spray temperature at an inlet portion was 80° C., and the dry air amount was 0.5 m³/min. The spray temperature at the inlet portion refers to the temperature at which dry air is fed into the chamber 412 in order to dry the sprayed slurry 200 for the catalyst. Furthermore, the amount of feed of the slurry for the catalyst to the atomizer 414 was 10 ml/min.

In step S115 (FIG. 1), the composite powder 300 (FIG. 2) produced in step S110 was dried by using the vacuum dryer 450. The drying conditions were that the temperature was 80° C., the pressure was 10 Torr, and the drying period was 2 hours. As a result of this drying step, the camphor 10 was removed by sublimation from the composite powder 300 to produce the catalyst powder 350 in a hollow particle form. Incidentally, the particle diameter of the catalyst powder 350 was about 2 to 3 μm.

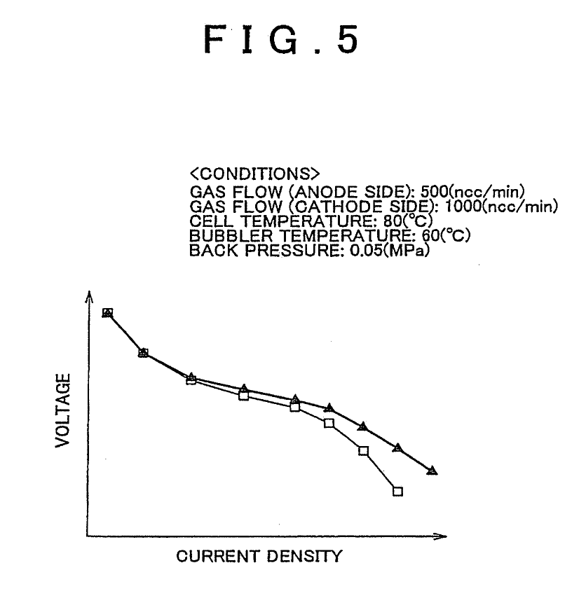

FIG. 5 is an illustrative diagram showing the current-voltage characteristic of a fuel cell employing the catalyst powder that was produced in this embodiment, and the current-voltage characteristic of a comparative example. In this embodiment, a fuel cell 100 (FIG. 3) was manufactured by using the catalyst powder 350 produced as described above. The cathode-side catalyst layer 72 of the fuel cell 100 was formed as described below. That is, the catalyst powder 350 was applied by the electrostatic screen method to a carbon paper that was to constitute the cathode-side gas diffusion layer 82, in such a fashion that the amount of application became 0.5 mg/cm². The anode-side catalyst layer 73 was formed in substantially the same manner.

Then, the electrolyte membrane 60 was sandwiched by two carbon papers on each of which the gas diffusion layer was formed, and was subjected to hot pressing to form the MEA 24. The thus-formed MEA 24 was sandwiched and fastened between the cathode-side separator 92 and the anode-side separator 93 to manufacture the fuel cell 100. Incidentally, although a common fuel battery system has a construction in which a plurality of fuel cells 100 are stacked, the I-V characteristics of the embodiment and the comparative example were obtained with-regard to unit cells.

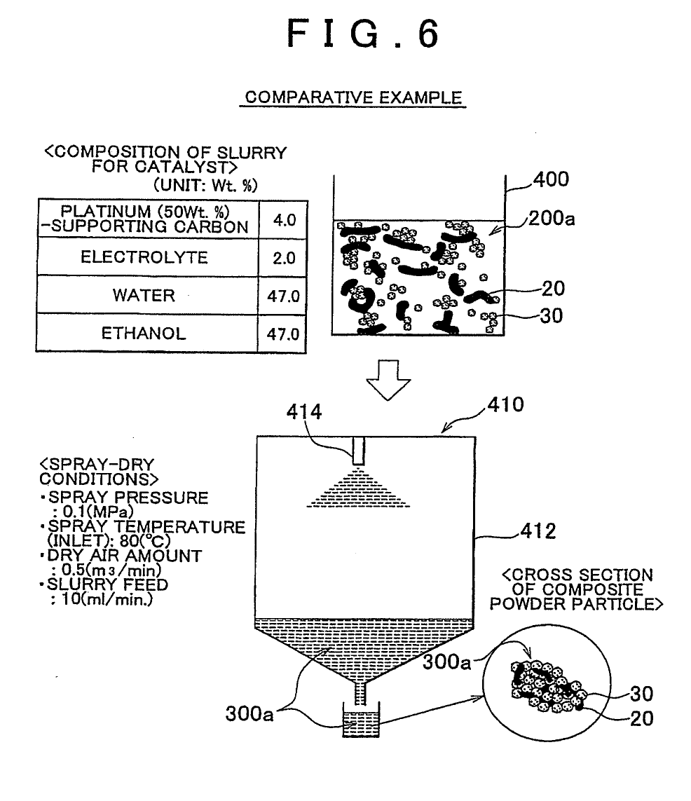

FIG. 6 schematically shows a production procedure for a catalyst powder in the comparative example. The comparative example is different from the foregoing embodiment in that the pore-forming material (camphor) was not used as a material of the catalyst powder, and that step S115 (the step of removing the pore-forming material) was omitted in the catalyst powder production process, and is the same in the other respects as the embodiment.

Concretely, the platinum-supporting carbon (50 wt. % of the supported platinum) 30, the electrolyte 20 and a solvent made up of water and ethanol were mixed so that the composition of the slurry 200 for the catalyst (FIG. 6) became as follows. That is, the composition thereof was 4.0 wt. % of the platinum-supporting carbon (50 wt. % of the supported platinum), 2.0 wt. % of the electrolyte, 47.0 wt. % of water, and 47.0 wt. % of ethanol.

In the comparative example, the slurry 200 for the catalyst was spray-dried under the same spray dry conditions as in the foregoing embodiment, so that a composite powder (catalyst powder) 300a was obtained. Incidentally, the composite powder 300a was in the form of particles made up of the platinum-supporting carbon 30 and the electrolyte 20, and the particles thereof did not have an interior hole, unlike the composite powder of the embodiment of the invention. In the comparative example, by using the thus-produced composite powder 300a as a catalyst powder, a fuel cell was manufactured by substantially the same method as in the embodiment.

In the examples shown in FIG. 5, the fuel cells manufactured in accordance with the embodiment and the comparative example were operated under the following conditions, and the I-V characteristics as shown in FIG. 5 were obtained. That is, the amount of flow of the fuel gas (hydrogen gas) at the anode side was 500 ncc/min, and the amount of flow or the oxidizing gas (air) at the cathode side was 1000 ncc/min. Besides, the cell temperature was 80° C., the bubbler temperature was 60° C. at both the anode side and the cathode side, and the back pressure was 0.05 MPa at both the anode side and the cathode side.

As shown in FIG. 5, the voltage value exhibited by the embodiment was higher than the voltage value exhibited by the comparative example for the same current density. This shows that the fuel cell 100 of the embodiment (i.e., black triangles in FIG. 5) was higher in power generation efficiency than the fuel cell of the comparative example (i.e., hollow squares in FIG. 5). This may be considered to be because in the fuel cell 100 of the embodiment, the holes within the particles of the catalyst powder were utilized and water management was realized such that the amount of water became appropriate.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

Hereinafter, modifications of the embodiment will be described. Although in the foregoing embodiment, the camphor 10, which sublimes at relatively low temperature, is used as the pore-forming material, the pore-forming material is not limited to a substance that has such a sublimation property, that is, it is permissible to adopt an arbitrary substance that is capable of changing in state when heated and therefore capable of being removed from the composite powder. For example, a thermolytic organic high-molecular compound, such as polyacetal, Avicel® of the FMC Corporation may be used.

In addition, it is also permissible to use a substance that is removable from the composite powder by washing with water or washing with alkaline water as well as the substance that is removable by heating. For example, water-soluble inorganic salts and the like, such as sodium chloride, potassium chloride, etc., inorganic salts and the like soluble in alkaline aqueous solutions, etc., may be used. In the case where any of these substances is used as the pore-forming material, the pore-forming material may be removed from the composite powder by performing the washing with water or the washing with alkaline water in step S115 in FIG. 1. That is, generally, an arbitrary method of removing the pore-forming material from the composite powder may be adopted in the catalyst powder production process of the invention.

Furthermore, although in the foregoing embodiments and the like, the slurry for the catalyst is spray-dried in order to produce the composite powder, other methods may also be adopted for that purpose. For example, the composite powder may also be produced by utilizing a phenomenon in which if the catalyst-supporting particles, the electrolyte and the pore-forming material are subjected to mechanical energy (e.g., compression), the materials become consolidated and composited with each other (a so-called “mechanochemical phenomenon”). Incidentally, in the case where the composite powder is produced by utilizing the mechanochemical phenomenon, the solvent becomes unnecessary.

As the composite powder manufacture device that utilizes the mechanochemical phenomenon, for example, Mechanofusion System® of Hosokawa Micron Corporation, Mechano Micros® of Nara Machinery Co., Ltd. may be used. That is, generally, an arbitrary method capable of producing a composite powder having a structure in which the pore-forming material is covered with catalyst-supporting particles and an electrolyte may be adopted in the catalyst powder production process of the invention. Incidentally, in the case where the composite powder is produced by utilizing the foregoing mechanochemical phenomenon, the catalyst-supporting particles, the electrolyte and the pore-forming material that are mixed in a chamber for giving them mechanical energy correspond to “mixture” in the invention.

What is claimed is:

1. A catalyst powder production method for constructing a catalyst layer in a fuel cell, comprising:
forming a mixture that contains an electrolyte, a pore-forming material, and a catalyst-supporting particle that supports a catalyst;
producing a composite powder in which the catalyst-supporting particle and the electrolyte are attached to a periphery of the pore-forming material by using the mixture; and
producing a catalyst powder that has a hollow structure by removing the pore-forming material from the composite powder.

2. The catalyst powder production method according to claim 1, wherein:
the pore-forming material has a property that sublimes to a gas when heated; and
the pore-forming material is removed through sublimation by heating the composite powder.

3. The catalyst powder production method according to claim 1, wherein:
the mixture is formed to a slurry which further contains a solvent in addition to the electrolyte, the pore-forming material, and the catalyst-supporting particle; and
the composite powder is produced by spray-drying the slurry.

4. The catalyst powder production method according to claim 1, wherein the composite powder in which the catalyst-supporting particle and the electrolyte are attached to a periphery of the pore-forming material is produced by giving a mechanical energy to the catalyst-supporting particle, the electrolyte and the pore-forming material.

5. The catalyst powder production method according to claim 4, wherein the composite powder is produced by compressing the catalyst-supporting particle, the electrolyte and the pore-forming material.

6. The catalyst powder production method according to claim 3, wherein a weight ratio of the pore-forming material in the slurry is in a range of 0.1 wt. % to 4.0 wt. %.

7. The catalyst powder production method according to claim 6, wherein the weight ratio of the pore-forming material in the slurry is in a range of 0.3 wt. % to 2.0 wt. %.

8. The catalyst powder production method according to claim 1, wherein in the composite powder, an average particle diameter of the pore-forming material is larger than average particle diameters of the catalyst-supporting particle and the electrolyte.

9. The catalyst powder production method according to claim 8, wherein the average particle diameter of the pore-forming material is substantially 0.3 to 0.5 μm.

10. The catalyst powder production method according to claim 1, wherein the pore-forming material is formed with at least one species selected from the group consisting of camphor, naphthalene, α-naphthol, and para-dichlorobenzene.

11. A catalyst powder comprising:
an electrolyte; and
a catalyst-supporting particle that supports a catalyst, wherein the catalyst powder has a hollow structure.

12. A catalyst layer in a fuel cell, comprising the catalyst powder according to claim 11.
